(19) United States
(12) Patent Application Publication
(10) Pub. No.: US 2016/0063880 A1
(43) Pub. Date: Mar. 3, 2016

(54) ACTIVITY REPOSITORY

(71) Applicant: Apollo Education Group, Inc., Phoenix, AZ (US)

(72) Inventors: Anil Maipady, San Jose, CA (US); Raghavendra Reddy, Sunnyvale, CA (US); Sudhakar Subashchandrabose, San Jose, CA (US); Shridhar Navanageri, Sunnyvale, CA (US); Narender Vattikonda, San Jose, CA (US)

(21) Appl. No.: 14/470,071

(22) Filed: Aug. 27, 2014

(51) Int. Cl. G09B 7/00

(52) U.S. Cl. CPC G09B 7/00

(57) ABSTRACT

Techniques are described herein for storing and managing activity objects. The activity objects represent activities that are designed to achieve objectives. The activity model reflected in the activity objects allows the activity objects to be associated with objective objects that represent the objectives of the activities represented by the activity objects. A mechanism is provided to transition activity objects through various states, to allow people with various roles to each apply their own customizations to an activity before the activity is published in association with the syllabus of a particular course offering. Techniques are also described for collecting instrumentation data as users perform the activities associated with the activity objects, and for recommending activities based on previously collected instrumentation data.

### FIELD OF THE INVENTION

The present invention relates to an activity repository and, more specifically, to a repository in which a learning activity (or “learning content”) transitions through various states prior to being available for use in a particular offering of a particular course.

### BACKGROUND

As used herein, an “activity” is unit of work. A “learning activity” is a unit of work that contributes to learning. The number of learning activities that are made available to students in an online learning environment can be enormous. For example, an online learning environment may provide thousands of courses, each course may cover hundreds of topics, and each topic may have numerous learning activities. In some situations, a single topic may be taught through the use of any one of a plurality of available learning activities for that topic.

Learning activities may take many forms, such as quizzes, assignments, etc. In addition, learning activities may be provided in many formats, such as video, audio, text, etc. Given the quantity of learning activities used in an online learning environment, the various forms of those learning activities, and the various formats of those learning activities, it is desirable to provide a system capable of managing the learning activities. Such a system may not only organize the learning activities, but may monitor the effectiveness of the learning activities, and recommend which activity to use in any given set of circumstances.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates how an activity repository may be arranged to interact with other systems, according to an embodiment of the invention;

FIG. 2 illustrates stages through which an activity object may transition within the activity repository, according to one embodiment;

FIG. 3 illustrates stages through which a syllabus may transition within the activity repository, according to an embodiment;

FIG. 4 illustrates a simplified activity object model, according to one embodiment;

FIG. 5 illustrates the general steps involved in the delivery of an activity to a user's device, according to one embodiment;

FIG. 6 illustrates the general steps involved in capturing instrumentation data and using that data as a factor in recommending an activity to a user, according to an embodiment;

FIG. 7 is a block diagram illustrating the primary components involved in importation and exportation of activities;

FIGS. 8a and 8b illustrate fields of an activity object, according to an embodiment;

FIG. 9 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An activity repository service is provided that enables authoring, importing, exporting, storing and consumption of activities. The computing devices that consume activities managed by the activity repository service include, but are not limited to, mobile devices, personal computers, tablets or wearable technologies. Based on the usage of an activity, the activity repository service can track the most popular and/or effective activities. Based on the effectiveness of the activity on certain types of users, the activity repository can recommend different activities to different types of users to accomplish the same goal.

According to one embodiment, the activity repository service performs one or more of the following functions:
allows users to author different types of learning activities—Quiz, Assignment, e-book, video, audio, podcast, federated, Task.
delivers activities to any device—Mobile, Tablet, Desktop, Wearable Technology Devices
provides a model to represent many type of activities—Activity can be Learning Activity, Task Activity, etc.
determines the popular/effective learning activities based on the activity usage by the users.
provides a model to enable recommendation of learning activities
recommends activities to users based on popularity, and/or effectiveness of the activity to similar users
integrates content from federated content providers and delivers the content to any type of device.
creates task activities and recommends the tasks to users of the system.
integrates the task activities with federated content providers.
tracks usage of the learning activities.
associates activities (Task or Learning) with different types of Syllabus, like course template (CDG), faculty template, faculty draft, offering syllabus.
enables users to author activities and use the activities independently.
imports learning activities from external systems.
exports learning activities to be consumed by other systems.
provisions activities when they are created.
enables users to search learning activities using different criteria.
provides conditional delivery of learning activities.

These are merely examples of the types of functions the activity repository may perform, according to embodiments of the invention. These and other functions of the activity repository shall be described in greater hereafter.

According to one embodiment, the activity repository stores and delivers various types of activities. The activity repository can store, for example, quizzes, assignments, e-books, videos, audio files, podcasts, tasks, etc. In one embodiment, the activity repository also supports a system that is similar to a library mechanism. An external content provider can author the activity that contains the meta data about the content, meta data on how to render the content and additional meta data that is required for the external system during the consumption can be packaged as per the activity repository schema that shall be described in greater detail hereafter.

In one embodiment, the activity repository can be used to populate the activities that are specific to a user profile. Those activities and/or the user profile can be accessed either by the user or shared with others, depending on the access mechanism that the system provides.

In one embodiment, the activity repository supports grouping/sharding by tenant, course, and user, and also allows access to the archived data for infinite period.

In one embodiment, the system has a tracking mechanism that allows traversing through various states that an activity has gone through, to determine how the activity has evolved over time and to establish connections through various systems that the activity connects during this state transition.

In one embodiment, the activity repository also has versioning capability that can be used to run two activities that are genetically same, but have different characteristics (such as different way to display, different way to render etc), but meeting the same objective for a user. This allows the system to perform A/B testing to find out which activity performs better and eventually propagate the high performing activity back into the library with a higher rating so the activity can be recommended during the course template creation phase.

In one embodiment, the activity repository also allows partial updating of the activity object so that the payload can be extremely optimized over the network.

Different consuming applications/devices can define their own profile for the object containing the fields to retrieve that matches a given use-case.

This also allows a role/access-based expansion or collapsing of the activity model, as defined during the policy creation for the activity.

### Environment of the Activity Repository

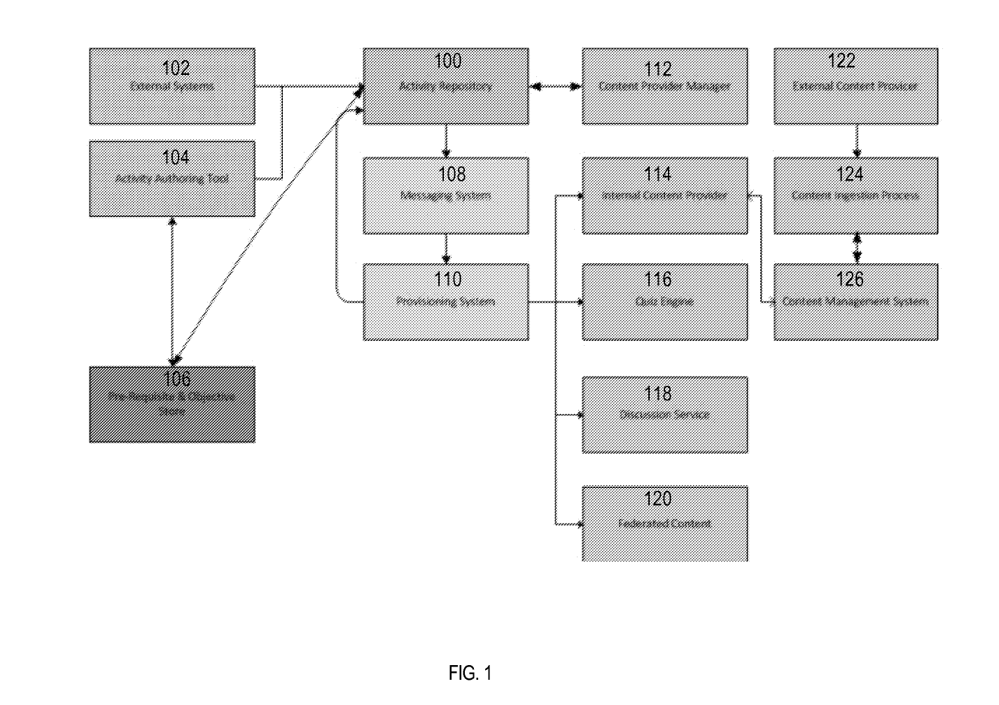

Referring to FIG. 1, it is a block diagram of an environment in which an activity repository 100 may be employed, according to one embodiment. Specifically, activity repository 100 is operatively coupled to one or more external systems 102, an activity authoring tool 104 and a pre-requisite and objective store 106.

Activity repository 100 is also coupled to a messaging system 108, a provisioning system 110, and a content provider manager 112. Provisioning system, in turn, is coupled to an internal content provider 114, a quiz engine 116, a discussion service 118 and federated content 120.

Internal content provider 114 is coupled to a content management system 126. Content management system 126, in turn, is coupled to content integration process 124 which is coupled to external content provider 122. Each of these elements of the environment in which activity repository 110 is employed shall be described in greater detail hereafter.

The connections between the components illustrated in FIG. 1 take many forms. In general, any form of connection may be used that allows information to be communicated from one component to another. For example, one or more of the connections may correspond to network connections, where data is transmitted over a local network, a wide area network, or both. Such network connections may be wired or wireless. As another example, one or more of the components may be implemented within the same computing device. In such a case, the communication between the components executing on the same computing device may be carried out over an internal bus of that computing device. The techniques described herein are not limited to any particular type of connection for communicating information between components.

### Creating an Activity

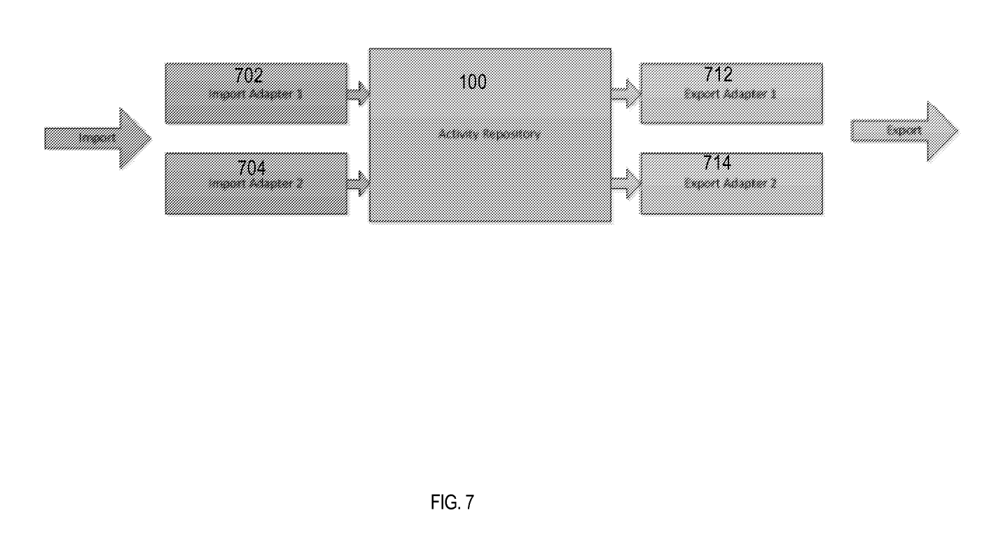

Referring again to FIG. 1, external systems 102 and activity authoring tool 104 represent sources from which activity repository 100 receives activity definitions. External systems 102 may, for example, be third-party activity authoring tools that do not necessarily produce activity definitions that conform to the activity model used by activity repository. How those activity definitions may be converted for use in activity repository 100 shall be described in greater detail hereafter with respect to FIG. 7.

According to one embodiment, various types of users (e.g. course developers, faculty and students) are able to create tasks themselves to organize their work towards learning. In response to receiving a new activity definition from external systems 102 or activity authoring tool 104, activity repository 100 sends a message to messaging system 108 indicating the arrival of the new activity definition. The messaging system 108, in turn, communicates with provisioning system 110 to provision the newly defined activity.

Based on the activity type, provision system 110 provisions appropriate content. Specifically, depending on the nature of the activity, provisioning system 110 communicates with internal content provider 114, quiz engine 116, discussion service 118, and/or federated content 120 to obtain the resources for provisioning the new activity. For example, if the activity is quiz activity, then based on the context in which activity is created an appropriate quiz is created. On the other hand, if the activity type is discussion, then based on the activity context, a discussion thread is created.

Activities may be pre-provisioned (provisioned before a request to engage in the activity) or provisioned on-the-fly in response to a request to engage in the activity. In one embodiment, most activities are provisioned prior to publication of a course that is going to make use of the activities. For example, before a math course is published, the quizzes that will be given in the math course are provisioned.

Various internal content providers 114 and external content providers 122 require different types of provisioning based on the method in which their contents are integrated with the activity repository 100. In one embodiment, the activities created in the activity repository 100 are not initially associated with any course/syllabus. Activities that are not yet associated with any course/syllabus are referred to herein as “Template Activities”.

In one embodiment, the syllabus creation process involves searching the activity repository 100 for the right set of activities for a syllabus, and associating those activities with the syllabus. If the right activity for achieving a particular goal is not found in the activity repository, a Template Activity for that goal may be created using the authoring tool 104.

### Activity Creation Example

Using the system illustrated in FIG. 1, a “quiz” activity may be created as follows. Initially, a generic “quiz” template may be created. The generic quiz template serves as a blueprint for creating quiz activities. As initially created, the quiz template is not associated with any particular course nor any particular subject. An instructional design developer (“IDD”) may that customize the quiz template to create a specific math quiz activity. Once the math quiz activity is created, a course design guide (“CDG”) for a particular math course may associate that math quiz activity with the particular math course. In addition, the course design guide may make further customization to the math quiz activity.

Once the course design guide finishes revising the math quiz activity, a faculty member that is going to teach a particular offering of the course may further customize the math quiz activity. If multiple offerings of the course are going to be taught by multiple distinct faculty members, then each faculty member may customize the quiz according to his/her own needs. Faculty that are not teaching that math course, but may teach that math course in the future, may also create their own customized version of the math quiz.

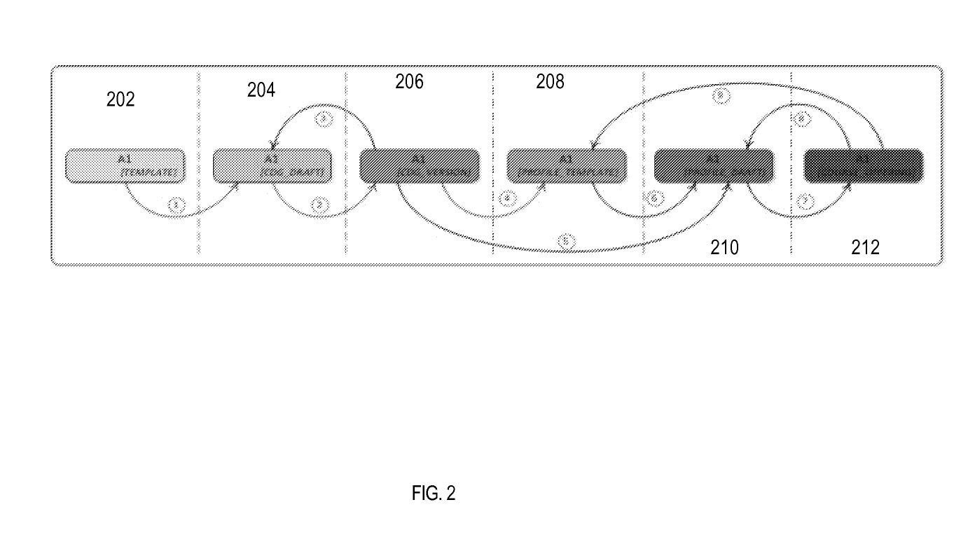

After a faculty member has finished revising all activities referred to in the syllabus of a particular course offering, the syllabus may be published, which in turn causes publication of the activities that have been customized for that course offering. Specific state transitions experienced by an activity object, according to one embodiment, are described hereafter in greater detail with reference to FIG. 2.

### Activity State Transitions

In the activity creation example given above, the quiz activity moves through numerous state transitions. These transitions are illustrated in FIG. 2. Referring to FIG. 2, in state 202, a blank template activity resides in the repository. Transition 1 from state 202 to state 204 occurs when a user (typically an IDD) uses the blank template activity to create CDG Draft activities. CDG Draft activities are tied to specific courses.

Transition 2 from state 204 to state 206 occurs when the IDD finalizes the CDG Draft activity, publishing the activity as a CDG Version activity that can be accessed, according to one embodiment, by faculty and students.

Transition 3, from state 206 back to state 204, occurs when an IDD wants to make a change to the CDG Version of the activity. Specifically, to change the CDG Version of the activity, the IDD creates a new CDG Draft activity from the CDG Version of the activity. After making the changes to the new version of the new CDG Draft, the new CDG draft is published an another CDG Version of the activity (transition 2).

Transition 4 from state 206 to 208 occurs when a faculty member wants to create a customized version of a CDG Version of the activity. Specifically, the faculty member creates a faculty template activity from a CDG Version of the activity, and applies any desired changes. The faculty-customized activity template is referred to herein as a “Profile Template Activity”. A Profile Template Activity is tied to the faculty member that created the Profile Template Activity.

Transition 5 from state 206 to state 210 occurs when a faculty member creates a Faculty Draft Activity from a CDG Version activity. Similar to the Profile Template Activity, the Profile Draft Activity is tied to the faculty member that created/customized it. However, in addition to being tied to the faculty member, a Profile Draft Activity is also tied to a particular course-offering id. At this point, the activity is provisioned, and some of the date-related fields of the activity may be populated using dates related to the specific course-offering to which the activity is tied.

Transition 6 from state 208 to state 210 is similar to transition 5, except that transition 6 occurs when a faculty member creates a Profile Draft activity from a Profile Template, rather than a CDG Version. As mentioned above, the Profile Draft activity thus created is tied to both the faculty member that created it and a particular course-offering id. Also similar to transition 5, transition 6 triggers the provisioning of the activity, and populating certain fields of the corresponding activity object (e.g. the offering date, etc.)

Transition 7 from state 210 to state 212 occurs when a faculty member tries to publish the Profile Draft syllabus. At transition 7 the activity repository 100 creates Course Offering activities from Profile Draft activities and deletes the corresponding Profile Draft activities. According to one embodiment, the Course Offering activities are read-only objects that nobody can change without publishing a replacement draft activity. The course offering version of an activity is the live offering version. Consequently, preventing changes to the Course Offering activities until their replacements are published prevents a situation in which users cannot access an activity of a published course offering.

Transition 8 from state 212 back to state 210 occurs when occurs when a course offering syllabus is edited. A course offering syllabus would be edited, for example, when a faculty member wants to make a change in a published course offering activity. Editing a course offering syllabus causes Profile Draft activities to be created from the course offering activities referenced in the syllabus. For example, if the Course Offering syllabus of a course offering refers to Course Offering activities A, B and C, then new Profile Draft activities A′, B′ and C′ would be created for the revised syllabus. The faculty member may then revise any of the Profile Draft activities A′, B′ and C′ as desired.

Transition 9 from state 212 back to state 208 occurs when a user creates a Profile Template Syllabus (for a new course-offering) from a previous Course Offering syllabus. This transition may occur, for example, when a faculty member is preparing the syllabus for a new offering of a course that was previously given. As a result of creating a new Profile Template Syllabus for the new course offering, new Profile Template activities are created for the new Syllabus based on the Course Offering activities that were in the previous Course Offering syllabus. For example, if the Course Offering syllabus of a previous course offering referred to Course Offering activities A, B and C, then new Profile Template activities A′, B′ and C′ would be created for the new Profile Template Syllabus.

By supporting the state transitions illustrated in FIG. 2, activity repository 100 provides great flexibility for faculty members that are preparing to offer a course. Specifically, to create the syllabus for their own course, they can:
copy the syllabus and activities from a previous offering of the same course
modify the syllabus and activities from a previous offering of the same course
create a brand new syllabus for their course offering
create brand new activities for their course offering
modify previously-existing activities for their course offering

In addition, the same faculty member may create multiple templates of the same activity, and use different templates of that same activity in different offerings of the same class. For example, a faculty member may use template A for a particular quiz in the morning offerings of a math course, and template A′ for the quiz in afternoon offerings of the same math course. Over time, the faculty member can compare the results, and opt to use the better-performing version of the activity in all future offerings of the course.

### Syllabus State Transitions

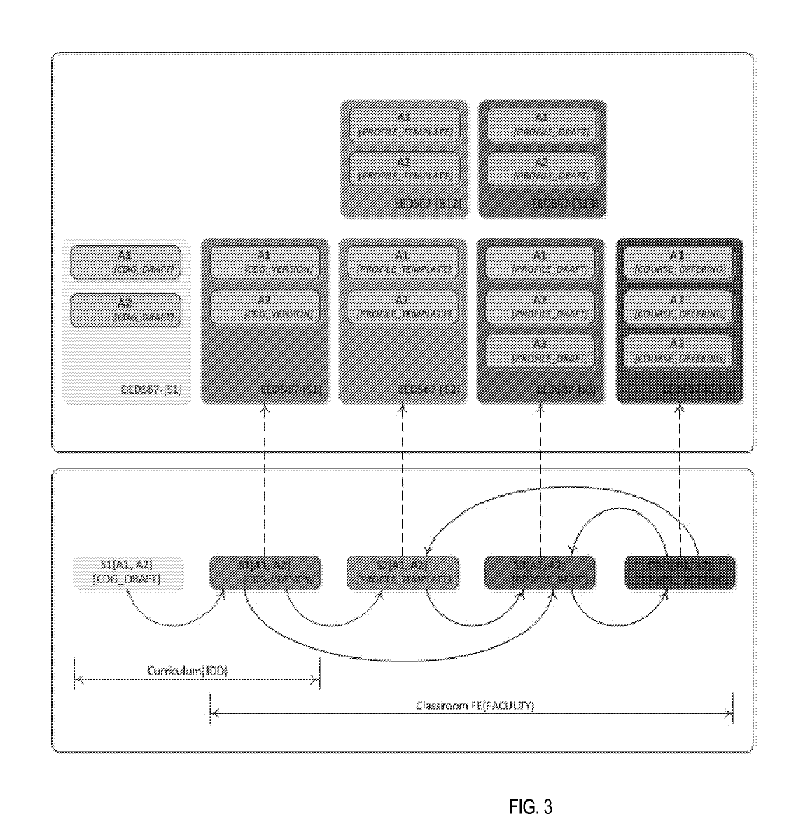

Referring to FIG. 3, it illustrates state transitions of a syllabus (S) for a course (course ID EED567). In the illustrated embodiment, the state transitions of a syllabus mirror those of the activities referred to in the syllabus. As a syllabus transitions from one state to another, activities in the syllabus transition through the corresponding state. For example, when a syllabus transitions from a profile template syllabus (S2) to a profile draft syllabus (S3), the activities associated with the syllabus transition from profile template activities (A1 profile template and A2 profile template) to profile draft activities (A1 profile draft, A2 profile draft), and therefore are provisioned.

In the embodiment illustrated in FIG. 3, the faculty member has customized activities A1 and A2 in two distinct ways. For example, activities A1 and A2 may be customized one way for the current offering of a course, and a different way for a future offering of the course. For the purpose of illustration, it shall be assumed that the set of customized Profile Template activities for the current offering is illustrated as EED567-(S2), and the set of customized Profile Template activities for the future offering is illustrated as EED567-(S12).

For each of the Profile Template activity sets EED567-(S2) and EED567-(S12), the faculty member created Profile Draft activity sets (EED567-(S13) and EED567-(S3), respectively. In addition, the faculty member added a new Profile Draft activity A3 to the Profile Draft activity set EED567-(S3).

In the illustrated example, the faculty decided to use Profile Draft activity set EED567-(S3) for the current class offering, so the published syllabus (CO-1) has published versions (EED567-(CO-1) of the activities in the Profile Draft activity set EED567-(S3). Because Profile Draft activity set EED567-(S3) is tied to a particular course offering, but was not selected for use in that particular course offering, the activities in Profile Draft activity set EED567-(S3) may be discarded. If the customizations reflected in Profile Draft activity set EED567-(S3) are to be used in a future course offering, then new Profile Draft activities may be generated based on the Profile Template activities

### Activity Model

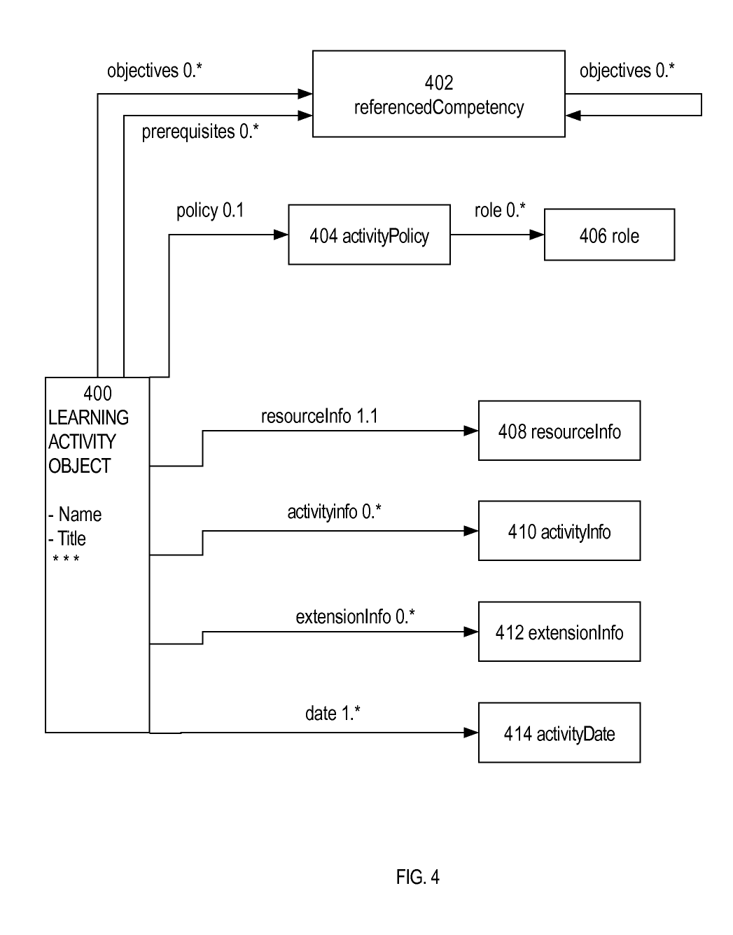

Referring to FIG. 4, it is a diagram illustrating an activity model that is used by activity repository 100 to represent activities, according to one embodiment. In the illustrated embodiment, the activity model includes numerous inter-related objects, each of which has fields for storing metadata that conveys information about activities stored in the repository.

Specifically, each activity stored in activity repository 100 is represented by a learning activity object. The schema of a learning activity object, according to one embodiment, is illustrated in block 400 of FIG. 4. As illustrated, each learning object has numerous fields, including fields for basic information such as the name of the activity, the title of the activity, etc. In addition to having field for the basic information, the learning activity object includes fields for indicating the objectives of the activity and for capturing the outcome of a user's performance of the activity.

With respect to the objectives of an activity, the learning activity object includes an array of pointers entitled “objectives”. The indication “objectives 0.*” in FIG. 4 indicates that the “objectives” array of pointers in any given learning activity object may have as few as 0 pointers, and that there is no maximum number of pointers in the objectives array. Each pointer in the objectives array points to a “referencedCompetency” object.

Each referencedCompetency object pointed to by the objectives array of a learning activity object represents a “competency” associated with performance of the activity that is represented by the learning activity object. For example, if the activity is watching a video that teaches multiplication of fractions, then the objectives array for the activity may include a pointer to a referencedCompetency object associated with multiplication of fractions.

As another example, the activity may be writing a recursive function in JAVA. In this example, the objectives array may include a pointers to referencedCompetency objects for:
the objective “learning JAVA”
the objective “learning functions”,
the objective “learning object-oriented programming”, and
the objective “learning recursion”.

As illustrated in FIG. 4, a learning activity object may also have:
an array of “prerequisite” pointers that indicate which competencies should by mastered before engaging in the corresponding activity
an activity policy pointer to an activityPolicy object 404, the activityPolicy object indicates policies that govern the learning activity object (e.g. list of the access permissions of the activity). The activityPolicy object 404, in turn, may have a pointer to a role object 406. The role object 406 pointed to be an activity policy 404 defines the roles that have the specified permissions.
a recourseInfo pointer that points to a resourceInfo object 408 that indicates resources pointing to inline, self (references to the entities on the syllabus itself), metadata, and link to content.
an array of activityinfo pointers that point to activityInfo objects 410 that information related to the activity and how to display the content in the user interface.
an array of extensionInfo pointers that point to extensionInfo objects 410, the array of extensionInfo pointers extends the learning activity model to provide, for example, supporting material information, instructions, attributes, etc.
an array of date pointers that point to activityDate objects 410 that indicate things such as the publish start date, the publish end date, the due date, etc. associated with the activity.

FIG. 4 illustrates a simplified version of an activity model, for the purpose of explanation. Each of the objects illustrated in FIG. 4 may have numerous additional fields that are not shown in FIG. 4. For example, the referencedCompetency object 402 may have a “catalog” pointer. In one embodiment, the “catalog” pointer in a referencedCompetency object points to a catalog object (not shown) that indicates from which catalog the objective represented by the referencedCompetency object is defined.

According to one embodiment, the extensionInfo objects 410 contain fields for capturing miscellaneous additional information (e.g. links, resources, etc.) needed for the activity. In one embodiment, the extensionInfo objects 410 store name/value pairs that convey information related to the activity. The specific information conveyed in the name/value pairs may vary from activity to activity. For example, the name/value pairs in the extensionInfo objects 410 may define policies, resources, standards, etc., related to the activity, that are not stored elsewhere in the activity object. Using the extensionInfo objects 410 in this manner avoids the need to revise the entire activity model every time a new type of activity needs a new type of information.

For example, assume that the activity object does not have a field for storing user-age information, but a newly defined activity makes use of user-age information. Under these circumstances, rather than revise the format of the activity model for all types of activities, the activity object of the newly defined activity can point to an extensionInfo object that stores the name/value pair (user-age, XXX), where XXX is the age of the user to which the activity instance corresponds.

### Learning Activity Object Example

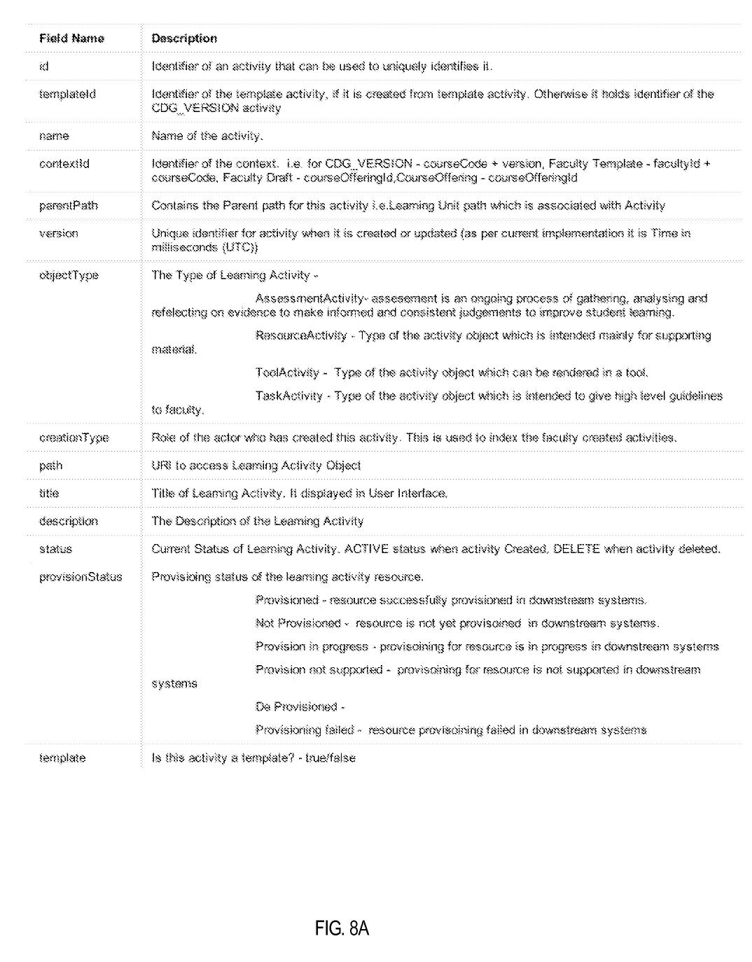

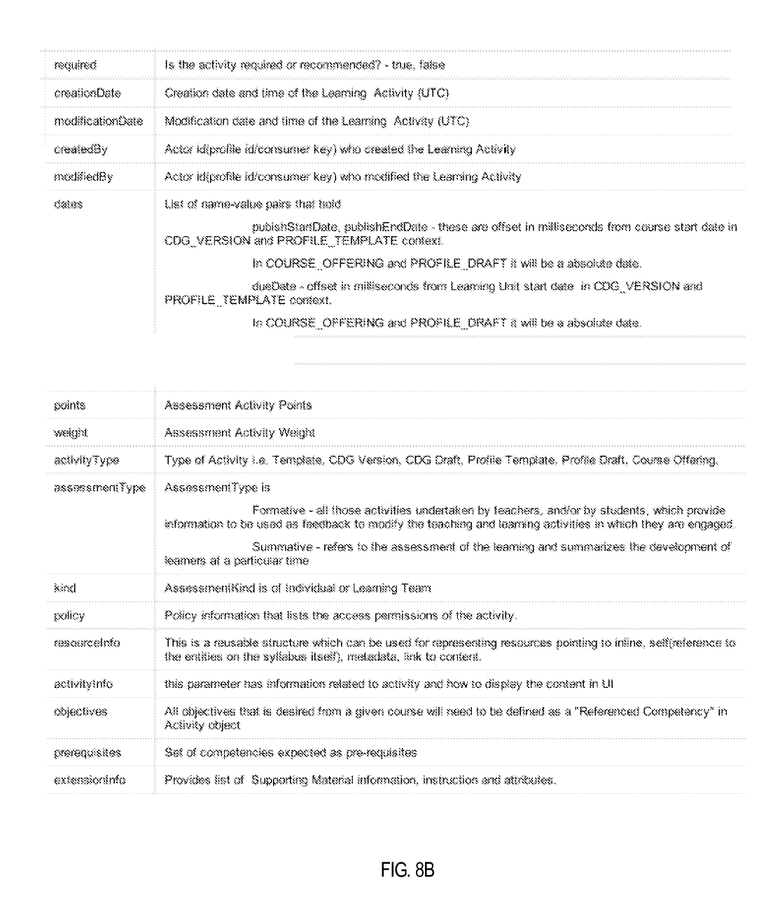

As mentioned above, the objects used to model learning activities may have significantly more fields than are illustrated in FIG. 4. For example, a given learning object may have the fields illustrated in FIGS. 8A and 8B. In the schema example illustrated in FIGS. 8A and 8B, the “points” field identifies the maximum number of points that may be earned by participating in the activity (e.g. the maximum “score” for the activity). The “weight” field indicates how much weight the score for this activity is given has. This weight is taken account when determining a user's aggregate score/grade for the course associated with the activity. The higher the weight of an activity, the more the activity's score affects the score of the course.

The fields illustrated in FIGS. 8a and 8b are merely examples of the fields that may be used to model an activity. Additional fields may include, for example, a “release condition” field that specifies conditions relative to whom the activity should be provided. For example, one activity may have a release condition that specifies that the activity is for students with a C average or below, while another activity, for the same objectives, may have a release condition that specifies that the activity is for students with B average or above.

An example of a learning object, stored in JSON format, is as follows:

### Interaction with Third Party Systems

According to one embodiment, activity repository 100 interacts with third-party systems in a variety of ways. For example, a learning activity object within activity repository may represent a quiz activity. For a user to actually take the quiz represented by that learning activity object, the quiz is first provisioned in a quizzing system (illustrated as provisioning system 110 in FIG. 1).

To facilitate the interacting with a provisioning system 110, the activity object has an array of pointers, where each pointer in the array points to a “resource info” object. Each “resource info” object pointed to by a learning activity object specifies resource parameters and context information.

The resource parameters may include any number of name/value pairs. In one embodiment, resource info objects include name/value pairs related to template info and name/value pairs associated with instance info. In the example of a quiz activity, the name/value pairs form the template info includes the information to be provided to a third party provisioning system 110 to provision an instance of the quiz. For example, the template info may include a quiz identifier that is used by the provisional system 110 to uniquely identify the quiz.

When activity repository 100 requests provisioning of the quiz by provisioning system 110, activity repository 100 communicates the quiz identifier to provisioning system 110. In response, provisioning system 110 creates an instance of the quiz for a particular student in a particular course.

Once provisioned, the instance info, in a resource info object associated with the learning activity object, is updated with metadata about the new instance of the quiz. The quiz instance metadata may include, for example, an identifier that uniquely identifies the quiz instance. The quiz instance identifier may, for example, be provided by the provisioning system 110 upon creating the new quiz instance.

When the student takes the quiz, quiz engine 116 presents the instance of the quiz to the user, and captures the results produced by the user taking the quiz. According to one embodiment, these results are stored in or linked to the instance of the quiz activity, and are therefore accessible using the instance information in the resource information object pointed to by the learning activity object.

### Finding Activities Based on Objectives

As mentioned above, the activity repository 100 uses a model that stores competency objects (referencedCompetency 402) separate from (but linked to) activity objects. The referencedCompetency objects 402, in turn, point to catalogs that define the competencies. Thus organized, the process of identifying a learning activity to teach certain concepts is simplified. Specifically, identifying a learning activity that teaches recursive functions in JAVA may be performed by running a query against the catalogs that define the objects, using search terms related to “recursive functions” and “JAVA”. Having identified the matching definitions in the catalogs, identifiers of the corresponding referencedCompetency objects are obtained. Those identifiers are used to identify the corresponding referencedCompetency objects. The learning activity objects that are linked to those referencedCompetency objects are then identified. Once the learning activity objects are identified, one or more of the activities may be recommended and/or delivered to the user that performed the search.

### State Transitions

In order to support to various syllabus workflows an activity may go through various state transitions. Activity state transitions are illustrated in FIG. 2, according to one embodiment. Referring to FIG. 2, a blank template is filled out to create a template activity, illustrated as state 202.

The template activity is then used as a blueprint to create CDG Draft activities.

### Delivering Activities to Users

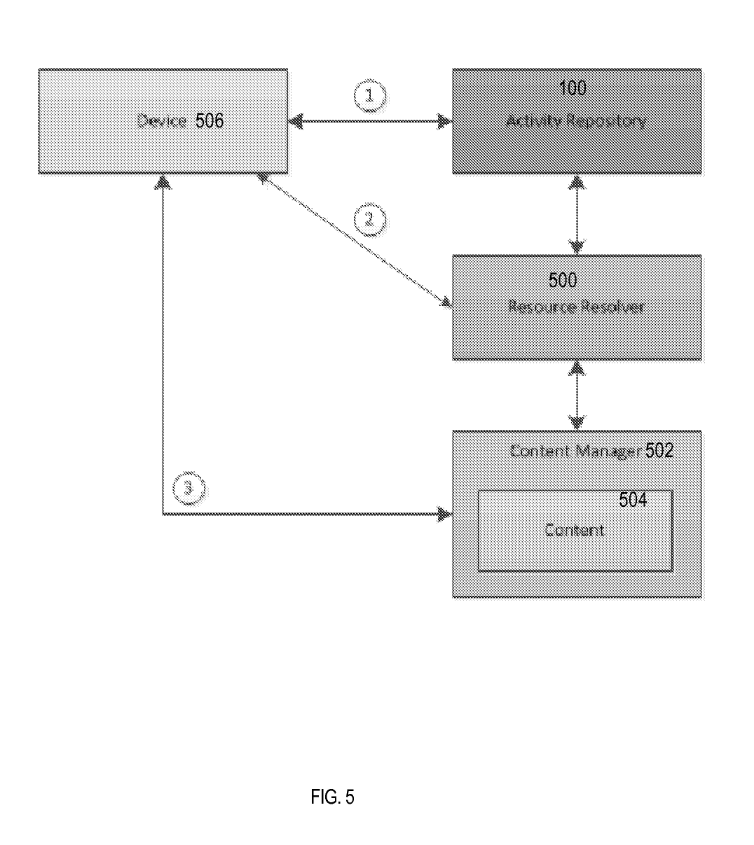

Once activities have been created, stored in the activity repository 100, and associated with a particular course, the activity is provided to users taking that course. The general steps involved in the delivery of an activity to a user's device are illustrated in FIG. 5.

Referring to FIG. 5, an application running on device 506 fetches an activity and renders the activity on device 506. Specifically, activity repository 100 creates a resource URL that points to a resource resolver service 500. When a user of device 506 clicks on a control that is associated with the URL, the device 506 makes a call to resource resolver 500. Resource resolver 500 then determines the appropriate content to send to device 506 based on the capabilities of device 506 and the formats available for the resource.

The logic used by resource resolver 500 may determine which content is appropriate in a variety of ways. Various techniques for determining appropriate content to provide to a user are described:
U.S. patent application Ser. No. 13/007,147, filed Jan. 14, 2011, entitled “Dynamically Recommending Learning Content”, and
U.S. patent application Ser. No. 13/007,177, filed Jan. 14, 2011, entitled “Recommending Competitive Learning Objects”
   the contents of each of which are hereby incorporated for reference.

Once resource resolver has determined the appropriate content for the particular situation, a “content URL” for the content is sent from resource resolver 500 to the device 506. Device 506 then uses the content URL to fetch content 504, managed by content manager 502. Such content 504 take any form that is capable of being rendered by device 506. For example, the content 504 may include text, audio, video, etc.

### Recording Activity Usage and Outcome

As content associated with an activity is rendered on a user's device, the user's interactions are recorded. Such recorded interactions may then be used by a recommendation engine to determine which activities to recommend to particular types of users in the future.

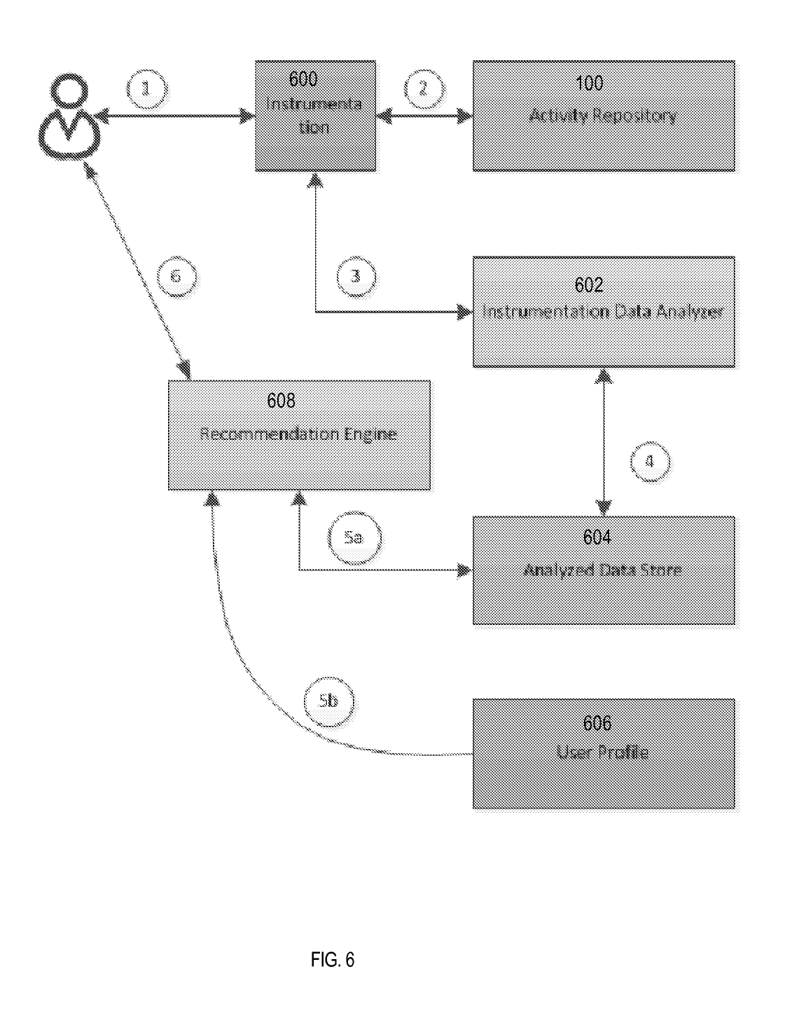

Referring to FIG. 6, an instrumentation module 600 records the user interactions with an activity obtained from the activity repository 100. The information thus recorded is referred to herein as “instrumented data”. In the case where the activity is a quiz, the instrumentation data may, for example, indicate the user's answers to the quiz. According to one embodiment, the instrumented data is fed to a data analyzer 602. In the illustrated embodiment, the data analyzer 602 stores the analyzed data (e.g. the product of the analysis of the instrumentation data) in an analyzed data store 604.

The data analyzer 602 may, for example, determine based on the instrumentation data (a) whether the activity is more popular than other activities for achieving the same objectives, and (b) whether the activity is more effective than other activities for achieving the same objectives.

When a subsequent user needs to perform an activity associated with certain objectives, recommendation engine 608 uses the analyzed data in data store 604, in combination with user profile data 606 of the user to whom the recommendation is to be given, to recommend an appropriate activity to the user to achieve the objections (e.g. mastery of fractions). The recommendation could be a learning activity or a task activity.

For example, assume that three activities A, B, C are available to achieve the same objective. When a user requests an activity to achieve that objective, recommendation 608 may retrieve from data store 604 data that indicates the popularity of each of activities A, B and C, and indicates overall effectiveness of each of activities A, B and C. In addition, recommendation engine 608 may obtain, from the provide 606 of the user, information about the user's past academic history (classes taken, tests taken, class grades, test scores), preferences (e.g. audio over text), etc. Based on this information, recommendation engine 608 selects one of activities A, B and C to recommend to the user.

### Importing and Exporting Activities

According to one embodiment, mechanisms are provided for importing activities into activity repository 100 from external sources (e.g. external system 102 of FIG. 1), and for exporting activities from activity repository 100 to external sources. FIG. 7 is a block diagram illustrating the primary components involved in the importation and exportation of activities, according to one embodiment.

Referring to FIG. 7, it illustrates two import adapters 702 and 704 configured to import activities from external sources. In particular, import adapter 702 has logic for converting activities from whatever format is used by first source system (e.g. SCORM) to the model used by the activity repository 100. Similarly, import adapter 704 has logic for converting activities from whatever format is used by a second source system to the model used by the activity repository 100. Thus, the format of the data produced by import adapters 702 and 704 is the same, but the formats used by the different external sources may by very different.

In addition, two export adapters 712 and 714 are configured to export activities from activity repository 100 to external systems. In particular, export adapter 712 has logic for converting activities from the model used by the activity repository 100 to whatever format is used by first target system. Similarly, export adapter 714 has logic for converting activities from the model used by the activity repository 100 to whatever format is used by a second target system. Thus, the format of the data input to import adapters 702 and 704 is the same, but the formats output to the different external targets may by very different.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

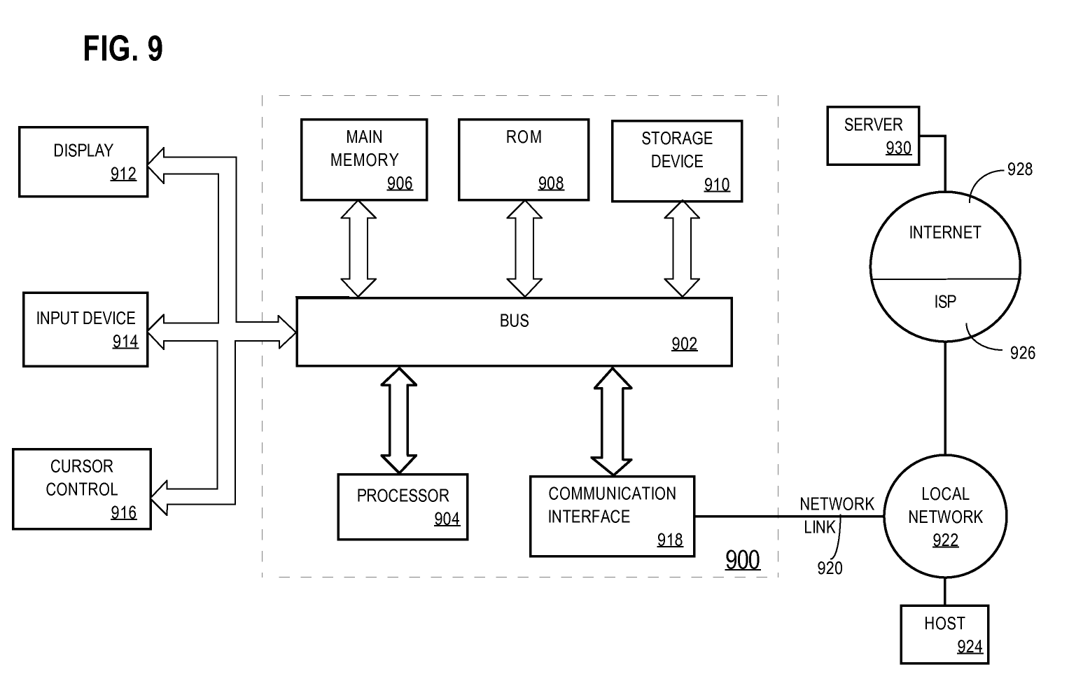

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing, within an activity repository, activity objects that represent activities;
wherein the activity objects stored in the activity repository include a particular activity object;
wherein the particular activity object represents a particular activity;
transitioning the particular activity object through a plurality of states until the particular activity object is published in association with a particular course offering;
wherein the plurality of states include at least:
a profile template state in which the particular activity object is associated with a particular course but not with any particular course offering; and
a profile draft state in which the particular activity object is associated with the particular course and the particular course offering;
wherein the method is performed by one or more computing devices.

2. The method of claim 1 further comprising:
storing, within the activity repository, data that associates the particular activity object with one or more objective objects; and
wherein the one or more objective objects represent one or more objectives that may be achieved through performance of the particular activity.

3. The method of claim 1 further comprising automatically provisioning the particular activity as the particular activity transitions from the profile template state to the profile draft state.

4. The method of claim 1 wherein:
in the profile template state, the particular activity object is not yet published for the particular course offering of the particular course; and
the plurality of states include a course offering state in which the activity object is published for the particular course offering of the particular course.

5. The method of claim 1 wherein:
the particular activity object is a first activity object for the particular activity;
the method further comprises the activity repository enabling users to modify the particular activity object, while in the profile template state, to create a second activity object for the particular activity for the particular course;
wherein the second activity object represents a modified version of the particular activity.

6. The method of claim 1 further comprising:
storing, within the activity repository, a syllabus for the particular course;
storing data that associates the syllabus with the particular activity object;
transitioning the syllabus through two or more states until the syllabus is published in association with the particular course offering;
wherein the activity object is published in association with the particular course offering in response to the syllabus being published in association with the particular course offering.

7. The method of claim 1 further comprising creating an instance of that particular activity object for a particular user in the particular course offering of the particular course.

8. The method of claim 7 further comprising automatically capturing instrumentation data as the particular user engages in the particular activity.

9. The method of claim 8 further comprising a recommendation engine automatically recommending a selected activity to a second user based, at least in part, on a profile of the second user and the instrumentation data captured from the particular user.

10. The method of claim 2 wherein:
the one or more objective objects are among a plurality of objective objects maintained in the activity repository;
each objective object, of the plurality of objective objects, is associated with a respective objective; and
the method further comprises identifying one or more activity objects to recommend to achieve a target objective by:
searching the plurality of objective objects to identify at least one matching objective object that matches the target objective; and
identifying the one or more activity objects that are associated with the at least one matching objective object.

11. One or more non-transitory computer-readable media storing instructions which, when executed by one or more computing devices, cause the one or more computing devices to perform a method comprising:
storing, within an activity repository, activity objects that represent activities;
wherein the activity objects stored in the activity repository include a particular activity object;
wherein the particular activity object represents a particular activity;
transitioning the particular activity object through a plurality of states until the particular activity object is published in association with a particular course offering;
wherein the plurality of states include at least:
a profile template state in which the particular activity object is associated with a particular course but not with any particular course offering; and
a profile draft state in which the particular activity object is associated with the particular course and the particular course offering.

12. The one or more non-transitory computer-readable media of claim 11, wherein the method further comprises:
storing, within the activity repository, data that associates the particular activity object with one or more objective objects; and
wherein the one or more objective objects represent one or more objectives that may be achieved through performance of the particular activity.

13. The one or more non-transitory computer-readable media of claim 11 wherein the method further comprises automatically provisioning the particular activity as the particular activity transitions from the profile template state to the profile draft state.

14. The one or more non-transitory computer-readable media of claim 11 wherein:
in the profile template state, the particular activity object is not yet published for the particular course offering of the particular course; and
the plurality of states include a course offering state in which the activity object is published for the particular course offering of the particular course.

15. The one or more non-transitory computer-readable media of claim 11 wherein:
the particular activity object is a first activity object for the particular activity;
the method further comprises the activity repository enabling users to modify the particular activity object, while in the profile template state, to create a second activity object for the particular activity for the particular course;
wherein the second activity object represents a modified version of the particular activity.

16. The one or more non-transitory computer-readable media of claim 11 wherein the method further comprises:
storing, within the activity repository, a syllabus for the particular course;
storing data that associates the syllabus with the particular activity object;
transitioning the syllabus through two or more states until the syllabus is published in association with the particular course offering;
wherein the activity object is published in association with the particular course offering in response to the syllabus being published in association with the particular course offering.

17. The one or more non-transitory computer-readable media of claim 11 wherein the method further comprises creating an instance of that particular activity object for a particular user in the particular course offering of the particular course.

18. The one or more non-transitory computer-readable media of claim 17 wherein the method further comprises automatically capturing instrumentation data as the particular user engages in the particular activity.

19. The one or more non-transitory computer-readable media of claim 18 wherein the method further comprises a recommendation engine automatically recommending a selected activity to a second user based, at least in part, on a profile of the second user and the instrumentation data captured from the particular user.

20. The one or more non-transitory computer-readable media of claim 12 wherein:
the one or more objective objects are among a plurality of objective objects maintained in the activity repository;
each objective object, of the plurality of objective objects, is associated with a respective objective; and
the method further comprises identifying one or more activity objects to recommend to achieve a target objective by:
searching the plurality of objective objects to identify at least one matching objective object that matches the target objective; and
identifying the one or more activity objects that are associated with the at least one matching objective object.
